(19) United States
(12) Patent Application Publication
(10) Pub. No.: US 2011/0232067 A1
(43) Pub. Date: Sep. 29, 2011

(54) PHASE-TRANSITIONAL MATERIAL, METHOD OF MANUFACTURING THEREOF AND METHOD OF MANUFACTURING MODULE WITH PHASE-TRANSITIONAL MATERIAL

(75) Inventor: Sukbae Lee, Seoul (KR)

(73) Assignee: Quantum Energy Research Centre, Seoul (KR)

(21) Appl. No.: 13/132,466

(22) PCT Filed: Dec. 16, 2008
(86) PCT No.: PCT/KR2008/007451

§ 371 Date: Jun. 2, 2011

(30) Foreign Application Priority Data
Dec. 3, 2008 (KR) 1020080121623

(51) Int. Cl. B23P 11/00; H01B 1/22

(52) U.S. Cl. 29/428; 252/512

(57) ABSTRACT

A phase-transitional material, a method of manufacturing thereof, and a method of manufacturing a module with the phase-transitional material are disclosed. A phase-transitional material which contains a metal to form a coordinate bond and a solvent to dissolve the metal, a method of manufacturing the phase-transitional material, including removing oxygen and moisture in air by placing a metal under a vacuum condition (S1 step), preparing the metal as a powder or lamina, introducing the metal into a container having an open face under an inert gas atmosphere, and fastening a connection unit allowing a solvent to be introduced into the face and a vacuum state to be created (S2 step), achieving a temperature equilibrium by maintaining an ambient temperature at a boiling or freezing point of the solvent after maintaining the vacuum state for a predetermined time using the connection unit, and introducing the solvent through the connection unit (S3 step), preparing a solution by mixing the metal with the solvent in the container homogenously (S4 step), and storing the container at −10 to 10° C. to allow the solution to expand and flow out through the connection unit (S5 step), and a method of manufacturing a module with the phase-transitional material may produce highly-efficient electric energy by converting energy lost as heat into electric energy. Furthermore, a phase-transitional material with which heat may be effectively emitted from electronic equipment devices such as computers and a module with the phase-transitional material may be provided.

### TECHNICAL FIELD

The present invention relates to a phase-transitional material, a method of manufacturing thereof, and a method of manufacturing a module with the phase-transitional material, and more particularly, to a phase-transitional material, with which electric energy may be produced very efficiently by converting energy lost as heat into electric energy and furthermore heat may be effectively emitted from electrical devices such as computers, a method of manufacturing thereof, and a method of manufacturing a module with the phase-transitional material.

### BACKGROUND ART

Conventional heat power generation systems are a technology, by which heat energy is converted into electric energy, and are referred to as a Thermoelectric Power Generation (TPG). Researches on various thermoelectric materials showing characteristics that heat energy may be converted into electric energy have long been conducted.

In this field, the most efficient system ever developed is a thermoelectric power generation system using junction semiconductors (p-type/n-type semiconductor junctions). In terms of efficiency, the system gets about 15% power output and is commercialized, but the efficiency is very low.

TABLE 1

| Energy converter | Efficiency (%) |
|---|---|
| Glow lamp | 5 |
| Steam engine | 8 |
| Solar cell | 10 |
| Heat battery | 13 |
| Heat charge converter | 15 |
| Rotary engine | 18 |
| Fluorescent lamp | 20 |
| Internal-combustion engine | 25 |
| Solid-state laser | 30 |
| Steam generation | 32.5 |
| Industrial gas turbine | 34 |
| Aircraft gas turbine | 36 |
| Steam turbine | 39 |
| Steam turbine | 46 |
| Liquid fuel rocket | 47 |
| MHD generator | 50 |
| Fuel cell (hydrogen-oxygen) | 60 |
| Electricity storage cell (As of now) | 72 |
| Home gas stove | 85 |
| Battery | 90 |
| Hydropower turbine | 92 |
| Electric motor | 93 |
| Electric generator | 99 |

Referring to the above <Table 1>, converting efficiencies may be identified according to various energy converters.

Characteristics of thermoelectric materials may be expressed in the form of a figure of merit including the following Seebeck coefficient and is defined using the following <Math FIGS. 1 and 2>.

$${α}_{{T}_{high} {T}_{low}} ( T ) = \frac{{V}_{{T}_{high}} - {V}_{{T}_{low}}}{{T}_{high} - {T}_{low}} = \frac{d {V}_{{T}_{high} {T}_{low}}}{d T} \qquad < Math Figure 1 >$$

(Seebeck Coefficient)

$$Z = \frac{{α}^{2}}{λ ρ} \qquad < Math Figure 2 >$$

### (λ is a Thermal Conductivity, π is a Resistivity)

The figure of merit in the above Math FIG. 2 may be expressed in x-y coordinate form and is illustrated in FIG. 1. FIG. 1 is a graph of the figure of merit, a characteristic of thermal interface materials.

Referring to these, the unit of the Seebeck coefficient is usually μV/K, meaning an amount of voltage produced per Kelvin. Materials showing up to 1200 μV/K have been used, corresponding to, for example, Si/SiGe Quantum Well Thermoelectric materials.

When these materials are used, a temperature difference of 10 Kelvin may produce a voltage difference of about 0.012 V, and the corresponding figure of merit is known to have about 4.4.

The principle of thermoelectric power generation system is to use a phenomenon that a voltage is produced by a change of electron density, induced by a temperature difference. That is, free electrons are generated by temperature changes, and density differences in sites are generated by distribution of these free electrons, resulting in electric potential.

FIG. 2 shows the principle of the junction semiconductor as described above, in detail. Referring to FIG. 2, heat is absorbed in the external Absorbed Heat while the heat is being emitted into the external Released Heat. In a n-type semiconductor, electron flows caused by this temperature difference occur from the Absorbed Heat to the Released Heat. In a p-type semiconductor, hole flows occur from the Absorbed Heat to the Released Heat.

Thus, an electric potential difference occurs in both the terminals by constructing a multiplicity of n-type and p-type semiconductors alternately.

However, the n-type/p-type semiconductor junction may not produce more than 15% conversion efficiency, and a voltage difference which may be obtained at room temperature expected to be usually used is weak. On the contrary, there is a disadvantage that tens or hundreds of Kelvin temperature changes are needed in order to obtain a constant voltage available in workplaces.

The n-type/p-type semiconductor junction is strictly limited to a few actually usable materials. These materials are so large in volume and heavy in weight that it is difficult to use them in various applications. Thus, it is almost impossible to be portably used.

Furthermore, because a large amount of heat is generated in operation, the efficiency is progressively decreased and it is difficult to utilize the materials for high power generations.

Recently, computer systems using VLSI have been developed, and commercially in terms of energy efficiency of the computer itself, the development of materials capable of dissipating heat produced from VLSI is continuously needed. In this field, by inversely utilizing characteristics of thermoelectric materials as described above and using the principle that a system may be cooled as the voltage is applied, researches have been directed to a technology that aims to dissipate heat sources.

In the field that requires heat dissipation as described above, theme of the research may be largely divided into two modes. One is to use thermoelectric materials and the other is to absorb heat using a latent heat generated when multi-phase transition (MPT) materials go through phase transitions.

Based on Peltier effect application using a thermoelectric phenomenon in the above heat dissipating system, the characteristics of cooling heat sources directly from the CPU of a computer are used. However, in the opposite part externally connected, a larger amount of heat is generated by the second law of thermodynamics, resulting in displacement of the heat sources externally.

In this case, cooling characteristics are determined according to those of thermal interface materials. When heat is drawn in the contact mode, the system has a serious disadvantage that as heat should be cooled by overlappingly connecting Peltier devices with thickness of 5 mm, the weight and volume of the system become very large. When the system exceeds its cooling limit, it also has a problem that it may not perform its functions properly and the temperature around the system may rise further.

Thus, with regard to methods of dissipating heat sources by using MPT materials in a heat dissipating system, there is a need for developing new materials which have characteristics of absorbing heat depending on the intensity and kind of latent heat which the materials have themselves.

### DISCLOSURE OF INVENTION

### Technical Problem

The first technical problem that the present invention attempts to solve is to provide a phase-transitional material, with which a highly-efficient electric energy may be produced by converting energy lost as heat into electric energy, and furthermore with which heat generated from electronic equipment devices such as computers may be effectively emitted.

The second technical problem that the present invention attempts to solve is to provide a method of manufacturing a phase-transitional material, with which a highly-efficient electric energy may be produced by converting energy lost as heat into electric energy, and furthermore, with which heat generated from electronic equipment devices such as computers may be effectively emitted.

The third technical problem that the present invention attempts to solve is to provide a module using a phase-transitional material, with which a highly-efficient electric energy may be produced by converting energy lost as heat into electric energy, and furthermore, with which heat generated from electronic equipment devices such as computers may be effectively emitted.

### Technical Solution

In order to solve the first technical problem, the present invention provides a phase-transitional material wherein the material includes a metal to form a coordinate bond, and a solvent to dissolve the metal.

In an embodiment of the present invention, the solvent may have a characteristic of reversible multi-step phase transitions represented by Chemical Formula 1,

[M(R)ₙ]^{+a}(s)+ae⁻(in R solution) [symbol] [M(R)ₙ₋ₐ](s)+aR(g)−Qₙ(J) <Chemical Formula 1>

(M: Metal, R: Solvent, n=1, 2, . . . , 6, a=1, 2, . . . , 6, and Qₙ(J): amount of latent heat in the n^{th} step phase transition).

In order to solve the second technical problem, a method of manufacturing a phase-transition material, including removing oxygen and moisture in air by placing a metal under a vacuum condition (S1 step), preparing the metal as a powder or lamina, introducing the metal into a container having an open face under an inert gas atmosphere, and fastening a connection unit allowing a solvent to be introduced into the face and a vacuum state to be created (S2 step), achieving a temperature equilibrium by maintaining an ambient temperature at a boiling or freezing point of the solvent after maintaining the vacuum state for a predetermined time using the connection unit, and introducing the solvent through the connection unit (S3 step), preparing a solution by mixing the metal with the solvent in the container homogenously (S4 step), and storing the container at −10 to 10° C. to allow the solution to expand and flow out through the connection unit (S5 step), is provided.

In order to solve the third technical problem, a method of manufacturing a module using a phase-transition material, including removing oxygen and moisture in air by placing a metal under a vacuum condition (S6 step), preparing the metal as a powder or lamina, introducing the metal into each of a first and a second containers having an open face under an inert gas atmosphere, and fastening each of a first and a second connection units allowing a solvent to be introduced into the face and a vacuum state to be created (S7 step), achieving a temperature equilibrium by maintaining an ambient temperature at a boiling or freezing point of the solvent after maintaining the vacuum state for a predetermined time using the first and the second connection units, and introducing the solvent through the first and the second connection units (S3 step), preparing a solution by mixing the metal with the solvent in the first and the second containers homogenously (S4 step), storing the container at −10 to 10° C. to allow the solution to expand and flow out through the first and the second connection units (S5 step), and connecting the first and the second containers at room temperature and inserting an insulating material inbetween (S6 step), is provided.

### Advantageous Effects

As described above, by utilizing a phase-transitional material according to the present invention, a method of manufacturing thereof, and a method of manufacturing a module with the phase-transitional material, highly-efficient electric energy may be produced from conversion of energy lost as heat into electric energy, and furthermore, a phase-transitional material, with which heat generated from electronic equipment devices such as computers may be effectively emitted, and a module with the phase-transitional material may be provided.

### BRIEF DESCRIPTION OF DRAWINGS

FIG. 1 is a graph of the figure of merit, a characteristic of thermal interface materials.

FIG. 2 is a schematic diagram showing a thermoelectric system using n-type/p-type junction semiconductors.

FIG. 3 is a phase-transition graph with regard to a phase-transitional material according to the present invention.

FIG. 4 is a graph showing vapor pressures of metals for a phase-transitional material according to the present invention.

FIG. 5 is a graph showing vapor pressures of solutions in which lithium and ammonia/methyl amine are mixed.

FIG. 6 is a graph measuring voltages being generated when at room temperature the temperature difference from a phase-transitional material according to the present invention is 10° C., at different times.

FIG. 7 is a graph measuring voltages becoming extinct when at room temperature the temperature difference from a phase-transitional material according to the present invention is removed, at different times.

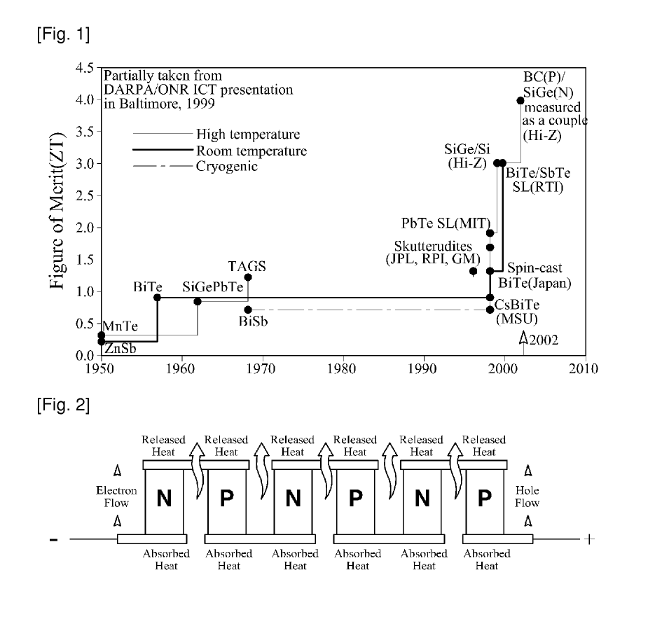

### BEST MODE FOR CARRYING OUT THE INVENTION

The present invention provides a phase-transitional material which includes a metal to form a coordinate bond, and a solvent to dissolve the metal.

According to an embodiment of the present invention, the solvent may have a characteristic of reversible multi-step phase transitions represented by Chemical Formula 1,

[M(R)ₙ]^{+a}(s)+ae⁻(in R solution) [symbol] [M(R)ₙ₋ₐ](s)+aR(g)−Qₙ(J) <Chemical Formula 1>

(M: Metal, R: Solvent, n=1, 2, . . . , 6, a=1, 2, . . . , 6, and Qₙ(J): amount of latent heat in the n^{th} step phase transition).

According to another embodiment of the present invention, the ratio of the metal to the solvent may be 1:0.1 to 1:6.

According to still another embodiment of the present invention, the metal may be at least one selected from the group consisting of lithium, barium, boron, sodium, magnesium, aluminum, potassium, calcium, scandium, vanadium, chromium, manganese, iron, cobalt, nickel, copper, gallium, selenium, rubidium, strontium, yttrium, niobium, molybdenum, technetium, ruthenium, rhodium, palladium, silver, indium, tellurium, cesium, lanthanide metals, and actinide metals.

According to yet another embodiment of the present invention, the solvent may be ammonia, ethylene diamine, hexamethylene diamine, melamine or amines with a carbon number of 4 or less as the length of the main chain, and salts thereof, amines containing phenyl groups and salts thereof, a polymer containing amides which include polyethylene amines in the main chain or polyamines which have amines connected to the main chain.

According to even another embodiment of the present invention, the solvent may be at least one selected from the group consisting of dimethyldistearylammonium, trimethyltetradecyl ammonium, trimethylhexadecyl ammonium, trimethyloctadecyl ammonium, benzyltrimethyl ammonium, benzyltriethyl ammonium, phenyltrimethyl ammonium, and aromatic quaternary ammoniums, cationic surfactants, and cationic polymers.

The present invention provides a method of manufacturing a phase-transitional material, including removing oxygen and moisture in air by placing a metal under a vacuum condition (S1 step), preparing the metal as a powder or lamina, introducing the metal into a container having an open face under an inert gas atmosphere, and fastening a connection unit allowing a solvent to be introduced into the face and a vacuum state to be created (S2 step), achieving a temperature equilibrium by maintaining an ambient temperature at a boiling or freezing point of the solvent after maintaining the vacuum state for a predetermined time using the connection unit, and introducing the solvent through the connection unit (S3 step), preparing a solution by mixing the metal with the solvent in the container homogenously (S4 step), and storing the container at −10 to 10° C. to allow the solution to expand and flow out through the connection unit (S5 step).

According to an embodiment of the present invention, the S5 step further comprises repeating steps from the S3 step such that the color of the solution becomes dark indigo.

According to another embodiment of the present invention, the solvent may have a characteristic of reversible multi-step phase-transitions represented by chemical formula 1,

[M(R)ₙ]^{+a}(s)+ae⁻(in R solution) [symbol] [M(R)ₙ₋ₐ](s)+aR(g)−Qₙ(J) <Chemical Formula 1>

(M: Metal, R: Solvent, n=1, 2, . . . , 6, a=1, 2, . . . , 6, and Qₙ(J): amount of latent heat in the n^{th} step phase transition).

According to still another embodiment of the present invention, the ratio of the metal to the solvent may be 1:0.1 to 1:6.

According to yet another embodiment of the present invention, the metal may be at least one selected from the group consisting of lithium, barium, boron, sodium, magnesium, aluminum, potassium, calcium, scandium, vanadium, chromium, manganese, iron, cobalt, nickel, copper, gallium, selenium, rubidium, strontium, yttrium, niobium, molybdenum, technetium, ruthenium, rhodium, palladium, silver, indium, tellurium, cesium, lanthanide metals, and actinide metals.

According to even another embodiment of the present invention, the solvent may be ammonia, ethylene diamine, hexamethylene diamine, melamine or amines with a carbon number of 4 or less as the length of the main chain, and salts thereof, amines containing phenyl groups and salts thereof, a polymer containing amides which include polyethylene amines in the main chain or polyamines which have amines connected to the main chain.

According to further another embodiment of the present invention, the solvent may be at least one selected from the group consisting of dimethyldistearylammonium, trimethyltetradecyl ammonium, trimethylhexadecyl ammonium, trimethyloctadecyl ammonium, benzyltrimethyl ammonium, benzyltriethyl ammonium, phenyltrimethyl ammonium, and aromatic quaternary ammoniums, cationic surfactants, and cationic polymers.

The present invention provides a method of manufacturing a module using a phase-transitional material, including removing oxygen and moisture in air by placing a metal under a vacuum condition (S6 step), preparing the metal as a powder or lamina, introducing the metal into each of a first and a second containers having an open face under an inert gas atmosphere, and fastening each of a first and a second connection units allowing a solvent to be introduced into the face and a vacuum state to be created (S7 step); achieving a temperature equilibrium by maintaining an ambient temperature at a boiling or freezing point of the solvent after maintaining the vacuum state for a predetermined time using the first and the second connection units, and introducing the solvent through the first and the second connection units (S8 step), preparing a solution by mixing the metal with the solvent in the first and the second containers homogenously (S9 step), storing the container at −10 to 10° C. to allow the solution to expand and flow out through the first and the second connection units (S10 step), and connecting the first and the second containers at room temperature and inserting an insulating material inbetween (S11 step).

According to an embodiment of the present invention, the S10 step further comprises repeating steps from the S8 step such that the color of the solution becomes dark indigo.

According to another embodiment of the present invention, the solvent may have a characteristic of reversible multi-step phase-transitions represented by chemical formula 1,

[M(R)ₙ]^{+a}(s)+ae⁻(in R solution) [symbol] [M(R)ₙ₋ₐ](s)+aR(g)−Qₙ(J) <Chemical Formula 1>

(M: Metal, R: Solvent, n=1, 2, . . . , 6, a=1, 2, . . . , 6, and Qₙ(J): amount of latent heat in the n^{th} step phase transition).

According to still another embodiment of the present invention, the ratio of the metal to the solvent may be 1:0.1 to 1:6.

According to yet another embodiment of the present invention, the metal may be at least one selected from the group consisting of lithium, barium, boron, sodium, magnesium, aluminum, potassium, calcium, scandium, vanadium, chromium, manganese, iron, cobalt, nickel, copper, gallium, selenium, rubidium, strontium, yttrium, niobium, molybdenum, technetium, ruthenium, rhodium, palladium, silver, indium, tellurium, cesium, lanthanide metals, and actinide metals.

According to even another embodiment of the present invention, the solvent may be ammonia, ethylene diamine, hexamethylene diamine, melamine or amines with a carbon number of 4 or less as the length of the main chain, and salts thereof, amines containing phenyl groups and salts thereof, a polymer containing amides which include polyethylene amines in the main chain or polyamines which have amines connected to the main chain.

According to further another embodiment of the present invention, the solvent may be at least one selected from the group consisting of dimethyldistearylammonium, trimethyltetradecyl ammonium, trimethylhexadecyl ammonium, trimethyloctadecyl ammonium, benzyltrimethyl ammonium, benzyltriethyl ammonium, phenyltrimethyl ammonium, and aromatic quaternary ammoniums, cationic surfactants, and cationic polymers.

### Mode for the Invention

Hereinafter, the present invention will be described in detail.

Here, preferred embodiments are provided for understanding of the present invention and illustrative purposes only, but the present invention should not be construed as limited to the embodiments. Furthermore, because the accompanying drawings may be exaggerated for better understanding of the present invention, the present invention should not be limited thereto.

A phase-transitional material according to the present invention includes a metal to form a coordinate bond, and a solvent to dissolve the metal. The metal may be one selected from Group 1 (alkali), Group 2 (alkali-earth), Group 3, transition metal, lanthanides, and actinides in the periodic table, and the solvent is one to form a coordinate bond with the metal. These solvents structurally have a form of coordinate bond and as environments such as concentration of the solvent, ambient temperature, and pressure change, the coordination number changes, leading to various phase transitions and change in number of coordination bonds.

In addition, the solvent has such a low boiling point that it may be easily evaporated, having a characteristic of reversible multi-step phase-transitions. This is described as in the following <Chemical Formula 1>.

[M(R)ₙ]^{+a}(s)+ae⁻(in R solution) [symbol] [M(R)ₙ₋ₐ](s)+aR(g)−Qₙ(J) <Chemical Formula 1>

(M: Metal, R: Solvent, n=1, 2, . . . , 6, a=1, 2, . . . , 5, and Qₙ(J): amount of latent heat in the n^{th} step phase transition)

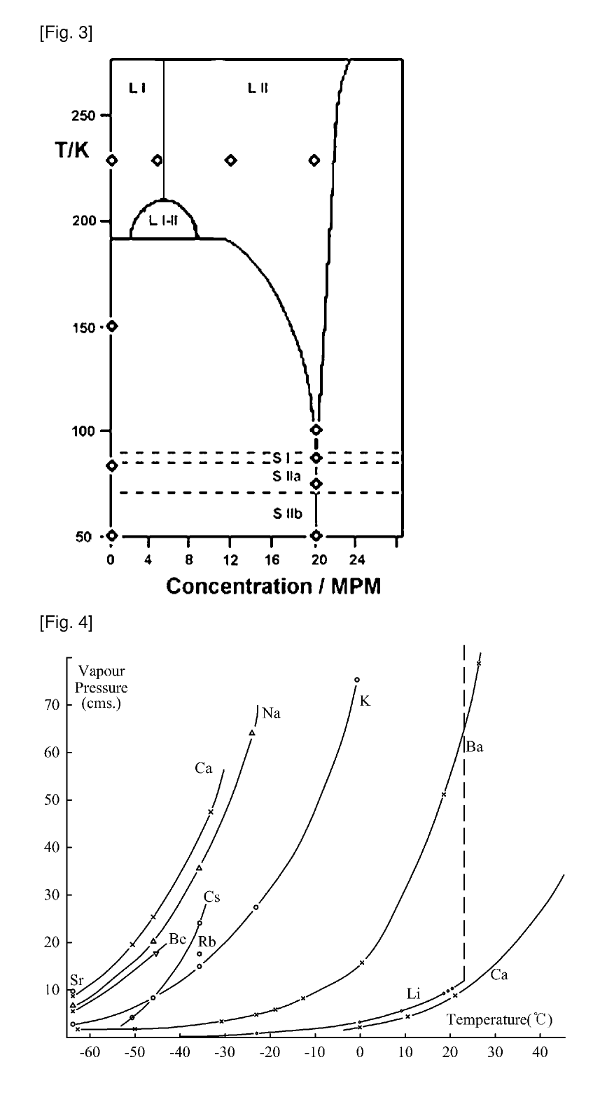

The characteristic of reversible multi-step phase-transitions may be described using FIG. 3. FIG. 3 is a phase-transition graph with regard to a phase-transitional material according to the present invention.

Referring to FIG. 3, the y axis denotes a temperature (K) and the x axis denotes a concentration. It may be known that MPM is an acronym of Mole Percent of Metal. It is a graph recorded when the metal is dissolved in amines including ammonia.

Here, the concentration at about 14.3 corresponds to [M(R)₆], and it may be known that concentrations at 20, 33, and 100 correspond to [M(R)₄], [M(R)₂], and [M] respectively.

When the concentration of the solvent (R) is thick, for example, MPM is 20 or more, [M(R)₆] usually exists at low temperatures (eg., −35° C.), but as the temperature goes up, the number of coordinate bonds decreases, resulting in variation in the oxidation state of the metal. Factors that affect these variations in the oxidation state may be usually environmental conditions such as mixing ratios between the metal and the solvent, temperatures, and internal pressures. It may be understood that there exists a stable bonded phase having constant coordination numbers with these environmental conditions.

When the [M(R)₆], a state in which a multiplicity of coordinate bonds exist, is described in more detail, it may be shown in FIG. 4 and FIG. 5 that as the temperature increases, the coordinate bonds are broken and the amounts of the solvents evaporated increases, resulting in the increase of partial pressures.

FIG. 4 is a graph showing vapor pressures of metals for a phase-transitional material according to the present invention and FIG. 5 is a graph showing vapor pressures of solutions in which lithium and ammonia/methyl amine are mixed.

As described above, potential variations with regard to the [M(R)₆], a state in which a multiplicity of coordinate bonds exist according to the solvents evaporated, are recorded in the following <Table 2>.

TABLE 2

| Metal | Voltage(V) | Enthalpy |
|---|---|---|
| [Li(R₅)]⁺¹ [symbol] [Li(R₆)]⁺² + e⁻ | 2.34 | −50 kcal |
| (in R solution) | | (at −33° C.) |
| [Na(R₅)]⁺¹ [symbol] [Na(R₆)]⁺² + e⁻ | 1.89 | −39 kcal |
| (in R solution) | | (at −33° C.) |
| [K(R₅)]⁺¹ [symbol] [K(R₆)]⁺² + e⁻ | 2.04 | −40 kcal |
| (in R solution) | | (at −33° C.) |
| [Rb(R₅)]⁺¹ [symbol] [Rb(R₆)]⁺² + e⁻ | 2.06 | −40 kcal |
| (in R solution) | | (at −33° C.) |
| [Cs(R₅)]⁺¹ [symbol] [Cs(R₆)]⁺² + e⁻ | 2.08 | −40 kcal |
| (in R solution) | | (at −33° C.) |

Unlike what may be seen in the <Table 2>, as a characteristic of a material, a formation of stable bonds at about room temperature (20° C.) occurs when the coordination number is 4. In this state, a potential difference which is approaching 0 but may reach up to 4 may be accompanied by a small amount of potential change (+δ).

The ratio of the metal to the solvent may be 1:0.1 or 1:6, and when the ratio is less than 1:0.1, the metal is very unstable and may exist just like an excited state at about 1000° C. When the ratio is more than 1:6, the solvent which is other than the phase exists as a liquid or gas state, not participating in reactions, and may hinder electrode production. High pressures may be also produced, inhibiting the operation of a stable system. The metal may be at least one selected from the group consisting of lithium, barium, boron, sodium, magnesium, aluminum, potassium, calcium, scandium, vanadium, chromium, manganese, iron, cobalt, nickel, copper, gallium, selenium, rubidium, strontium, yttrium, niobium, molybdenum, technetium, ruthenium, rhodium, palladium, silver, indium, tellurium, cesium, lanthanide metals, and actinide metals.

In addition, the solvent may be ammonia, ethylene diamine, hexamethylene diamine, melamine or amines with a carbon number of 4 or less as the length of the main chain, and salts thereof, amines containing phenyl groups and salts thereof, a polymer containing amides which include polyethylene amines in the main chain or polyamines which have amines connected to the main chain, and may be at least one selected from the group consisting of dimethyldistearylammonium, trimethyltetradecyl ammonium, trimethylhexadecyl ammonium, trimethyloctadecyl ammonium, benzyltrimethyl ammonium, benzyltriethyl ammonium, phenyltrimethyl ammonium, and aromatic quaternary ammoniums, cationic surfactants, and cationic polymers.

The method of manufacturing a phase-transitional material according to the present invention includes removing oxygen and moisture in air by placing a metal under a vacuum condition (S1 step), preparing the metal as a powder or lamina, introducing the metal into a container having an open face under an inert gas atmosphere, and fastening a connection unit allowing a solvent to be introduced into the face and a vacuum state to be created (S2 step), achieving a temperature equilibrium by maintaining an ambient temperature at a boiling or freezing point of the solvent after maintaining the vacuum state for a predetermined time using the connection unit, and introducing the solvent through the connection unit (S3 step), preparing a solution by mixing the metal with the solvent in the container homogenously (S4 step), and storing the container at −10 to 10° C. to allow the solution to expand and flow out through the connection unit (S5 step).

Referring to the S1 step, the step is to remove impurities such as moisture in air and oxygen, and the metal may be activated using materials such as hexane.

The vacuum state may be maintained preferably at 10⁻⁵ to 10⁻⁷ Torr, and if the pressure is less than 10⁵ Torr, the conversion efficiency may be reduced due to residual impurities. However, if the pressure is more than 10⁻⁷ Torr, the manufacturing costs may be increased due to excessive use of energy.

The solvent may have a characteristic of reversible multi-step phase-transitions represented by Chemical Formula 1. Because the description about these is the same as or similar to the above <Chemical Formula 1>, it is omitted here. This applies equally to what will be described later.

In addition, the ratio of the metal to the solvent may be 1:0.1 to 1:6, and the metal may be at least one selected from the group consisting of lithium, barium, boron, sodium, magnesium, aluminum, potassium, calcium, scandium, vanadium, chromium, manganese, iron, cobalt, nickel, copper, gallium, selenium, rubidium, strontium, yttrium, niobium, molybdenum, technetium, ruthenium, rhodium, palladium, silver, indium, tellurium, cesium, lanthanide metals, and actinide metals.

Furthermore, the solvent may be ammonia, ethylene diamine, hexamethylene diamine, melamine or amines with a carbon number of 4 or less as the length of the main chain, and salts thereof, amines containing phenyl groups and salts thereof, a polymer containing amides which include polyethylene amines in the main chain or polyamines which have amines connected to the main chain, and the solvent may be at least one selected from the group consisting of dimethyldistearylammonium, trimethyltetradecyl ammonium, trimethylhexadecyl ammonium, trimethyloctadecyl ammonium, benzyltrimethyl ammonium, benzyltriethyl ammonium, phenyltrimethyl ammonium, and aromatic quaternary ammoniums, cationic surfactants, and cationic polymers.

Next, the S2 step is a step in which the metal is prepared as a powder or lamina and introduced into a container which has an open face under an inert gas atmosphere, and a connection unit in which a solvent may be introduced through the face and a vacuum state may be created is fastened. The reactive surface area may be increased by preparing the metal as a powder or lamina, and the connection unit is equipped with a three-faced connector in the form of a T-shaped pipe. A first face may be connected to the container, a second face to a source of solvent supply, and a third face to a vacuum pump.

In addition, all the faces of the container except one are closed, for example, they are configured as a cylindrical shape.

Next, the S3 step is a step in which the vacuum state is maintained for some time through the connection unit, and then a temperature equilibrium is induced by maintaining the ambient temperature at a boiling or freezing point of the solvent, and the solvent is introduced through the connection unit.

In maintaining the temperature at a boiling or freezing point of the solvent, when the temperature is kept at above a boiling point of each organic solvent, difficulties in dissolving the metal may occur. On the contrary, when the temperature is kept at below a freezing point, a problem that the solvent is frozen and the synthesis of samples is not achieved may occur.

In addition, the above some time may be 20 minutes to 2 hours. When it is below 20 minutes, a sufficient dissolution reaction between solvent and metal may not be achieved and inhomogeneous samples may be prepared. On the contrary, when the time takes more than 2 hours, the process time of the step is so elongated that the overall manufacturing costs may be increased.

Next, the S4 step is a step in which a solution may be prepared by mixing the metal with the solvent in the container homogenously, and is a state in which the temperature is kept at about a boiling or freezing point of the solvent.

The S5 step is a step in which the container is stored at −10 to 10° C. and the solution is expanded and flown out through the connection unit. As the ambient temperature around the metal-solvent solution is increased, the volume of the solution is expanded and the solution is flown out through the connection unit.

When the externally flown solution is visually observed, the color often turns out to be transparent or colorless, or dark indigo. Because the dark indigo color is a typical color of [M(R)₆]²⁺, steps from the S3 described above should be repeated to get the dark indigo color when the color is transparent or colorless.

In addition, phase-transitional materials with these potential difference characteristics are hermetically sealed in an insulating state, and then construction of circuits with electrodes consisting of conductors at both the terminals may be applied for a thermoelectric system. A detailed explanation about this will be described later.

Furthermore, the chemical structure in this state exists together as a constant ratio of [M(R)₆]⁺²(s) to [M(R)₄](s). This ratio has an average value of n as may be seen in the following <Table 3> according to the ambient temperatures at which the hermetic sealing was performed.

TABLE 3
The variation of ‘n’ for the compound [M(R)ₙ]
as a function of Temperature

| Metal | Temperature (° C.) | n |
|---|---|---|
| Calcium | −63.8 | 5.67 |
| | −45.3 | 5.79 |
| | −33 | 5.900 |
| | 0 | 5.869 |
| | +20 | 5.825 |
| Strontium | −63.8 | 4.87 |
| | −45.3 | 4.92 |
| | −60 | 6.38 |
| | −23 | 6.15 |
| | 0 | 6.01 |
| Barium | −63.8 | 7.49 |
| | −45.3 | 7.55 |
| | −50 | 6.97 |
| | −23 | 6.30 |
| | 0 | 6.10 |

That is, it may be known that two states with potential differences exist together and a thermodynamically stable state is maintained.

A method of manufacturing a module with the phase-transitional material may include removing oxygen and moisture in air by placing a metal under a vacuum condition (S6 step), preparing the metal as a powder or lamina, introducing the metal into each of a first and a second containers having an open face under an inert gas atmosphere, and fastening each of a first and a second connection units allowing a solvent to be introduced into the face and a vacuum state to be created (S7 step), achieving a temperature equilibrium by maintaining an ambient temperature at a boiling or freezing point of the solvent after maintaining the vacuum state for a predetermined time using the first and the second connection units, and introducing the solvent through the first and the second connection units (S8 step), preparing a solution by mixing the metal with the solvent in the first and the second containers homogenously (S9 step), storing the container at −10 to 10° C. to allow the solution to expand and flow out through the first and the second connection units (S10 step), and connecting the first and the second containers at room temperature and inserting an insulating material inbetween (S11 step).

First, because the S6 step is the same as or similar to the S1 step described above, the description about this is omitted.

Next, the S7 step is a step in which the metal is prepared as a powder or lamina and introduced into a first container and a second container which have an open face under an inert gas atmosphere respectively, and a first and a second connection units in which each solvent may be introduced through each of the open faces and a vacuum state may be created are fastened. Except that two connection units are used for two containers respectively, the step is similar to the S2 step described above. Thus, the detailed description is omitted.

Next, the S8 step is a step in which the vacuum states are maintained for some time through the first and the second connection units, and then temperature equilibriums are induced by maintaining the ambient temperatures at a boiling or freezing point of the solvent, and the solvent is introduced through the first and the second connection units. Because the step is similar to the S3 step described above, the description is omitted.

Next, the S9 step is a step in which a solution may be prepared by mixing the metal with the solvent in the first and the second containers homogenously. Because the step is similar to the S4 step described above, the description is omitted.

Next, the S10 step is a step in which the first and the second containers are stored at −10 to 10° C. and the solution is expanded and flown out through the connection units. Because the step is similar to the S5 step described above, the description is omitted.

Next, the S11 step is a step in which the first and the second containers are connected at room temperature and a insulating material is inserted inbetween. The insulating material may be quartz here.

In addition, the S10 step may further include repeating steps from the S8 step in order to get a dark indigo color of the solution.

When a solution is prepared using lithium as the metal, characteristics are recorded in the following <Table 4>.

TABLE 4
Heats of reactions [Li(R₅)] + 1 [symbol] [Li(R₆)]⁺² + e⁻ (in R solution)

| C(moles liter⁻¹) | H(Kcal mole⁻¹) | C | H |
|---|---|---|---|
| +5° | | −15° | |
| 0.679 | −0.19 | | |
| 0.407 | −0.17 | 0.385 | +0.92 |
| 0.290 | −0.13 | 0.214 | +1.00 |
| 0.179 | −0.07 | 0.139 | +1.10 |
| 0.114 | +0.12 | 0.0638 | +1.40 |
| 0.0646 | +0.38 | 0.0360 | +1.74 |
| 0.0342 | +0.73 | 0.0293 | +1.84 |
| 0.0194 | +1.07 | 0.0179 | +2.22 |
| 0.0150 | +1.23 | 0.0149 | +2.32 |
| 0.0148 | +1.23 | 0.0090 | +2.75 |
| 0.0133 | +1.22 | | |
| 0.0058 | +1.58 | | |

As described in the <Table 4>, the reaction enthalpy shows characteristics of endothermic reaction or exothermic reaction with the temperature and concentration, and it may be known that these characteristics are clearly shown at around room temperature.

As the concentration of the metal increases, characteristics of exothermic reaction are displayed. Because [M(R)₆]⁺²(S) and [M(R)₄](s) shows characteristics of endothermic reaction at dilute concentrations, it may be known that as the reaction from potential differences caused by temperature differences proceeds, the reaction goes further while absorbing the external energy.

Due to these characteristics, the heat source part where the temperature is high shows characteristics of exothermic reaction and the reaction continues to goes forward, producing potential differences. In the opposite part of the heat source, partial pressures are increased by R(g) evaporated from the terminal and after all, Le Chatelier's principle makes the reaction go backward, produces a larger potential difference, causes an exothermic reaction, and emits heat generated from the heat source.

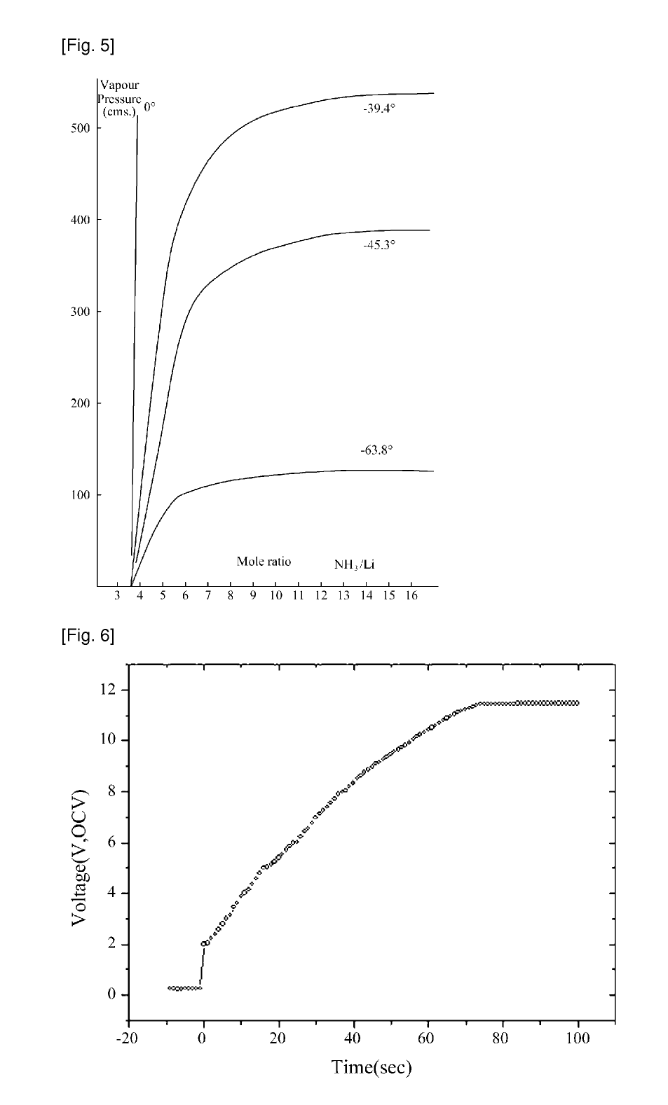

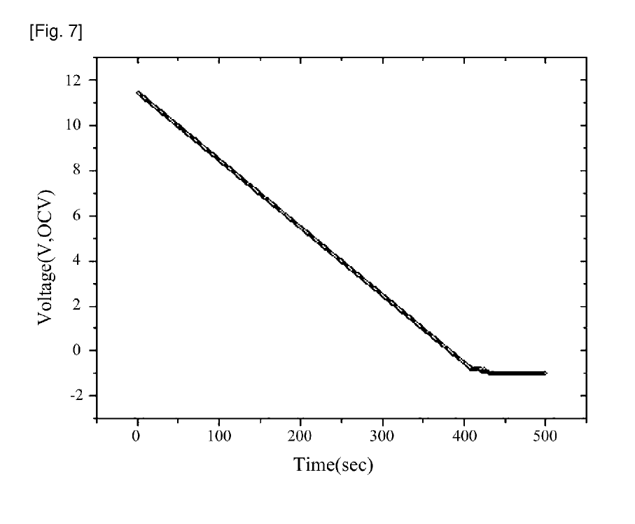

That is, when a temperature difference occurs, a voltage is generated in the high temperature part, solvent (R) is evaporated while absorbing the ambient heat. Partial pressures are thereby increased, making a coupling reaction goes backward in the opposite part, emitting the ambient heat, and producing a reverse voltage. These are shown in FIG. 6 and FIG. 7.

FIG. 6 is a graph measuring voltages being generated when at room temperature the temperature difference from a phase-transitional material according to the present invention is 10° C., at different times and FIG. 7 is a graph measuring voltages becoming extinct when at room temperature the temperature difference from a phase-transitional material according to the present invention is removed, at different times.

Referring to FIG. 6 and FIG. 7, a drastic voltage spike in a line by temperature differences at room temperature is shown, a proportional relationship is maintained, and then the line is converged to a constant voltage. On the contrary, when the temperature difference is removed at room temperature, a declining line with a constant slope is maintained until a thermal equilibrium state is reached, and then the line is converged to a constant voltage approaching 0.

### INDUSTRIAL APPLICABILITY

In a heat dissipating system, a method of dissipating heat sources using MPT materials is expected to provide a new energy source as a clean energy against high oil prices and climate change, using a new material which has a characteristic of absorbing heat depending on the intensity and kind of latent heat which the material has itself and to prevent malfunctions caused by high temperatures in various systems in advance. It is also expected that when the system is commercialized, it will play a more important role as an environmentally friendly energy source than any other alternative energy.

1. A phase-transitional material comprising a metal to form a coordinate bond, and a solvent to dissolve the metal.

2. The phase-transitional material of claim 1, wherein the solvent has a characteristic of reversible multi-step phase transitions represented by Chemical Formula 1,
[M(R)ₙ]^{+a}(s)+ae⁻(in R solution) [symbol] [M(R)ₙ₋ₐ](s)+aR(g)−Qₙ(J) <Chemical Formula 1>
(M: Metal, R: Solvent, n=1, 2, . . . , 6, a=1, 2, . . . , 6, and Qₙ(J): amount of latent heat in the n^{th} step phase transition).

3. The phase-transitional material of claim 2, wherein the ratio of the metal to the solvent is 1:0.1 to 1:6.

4. The phase-transitional material of claim 1, wherein the metal is at least one selected from the group consisting of lithium, barium, boron, sodium, magnesium, aluminum, potassium, calcium, scandium, vanadium, chromium, manganese, iron, cobalt, nickel, copper, gallium, selenium, rubidium, strontium, yttrium, niobium, molybdenum, technetium, ruthenium, rhodium, palladium, silver, indium, tellurium, cesium, lanthanide metals, and actinide metals.

5. The phase-transitional material of claim 1, wherein the solvent is ammonia, ethylene diamine, hexamethylene diamine, melamine or amines with a carbon number of 4 or less as the length of the main chain, and salts thereof, amines containing phenyl groups and salts thereof, a polymer containing amides which include polyethylene amines in the main chain or polyamines which have amines connected to the main chain.

6. The phase-transitional material of claim 1, wherein the solvent is at least one selected from the group consisting of dimethyldistearylammonium, trimethyltetradecyl ammonium, trimethylhexadecyl ammonium, trimethyloctadecyl ammonium, benzyltrimethyl ammonium, benzyltriethyl ammonium, phenyltrimethyl ammonium, aromatic quaternary ammoniums, cationic surfactants, and cationic polymers.

7. A method of manufacturing a phase-transitional material, comprising removing oxygen and moisture in air by placing a metal under a vacuum condition (S1 step);
preparing the metal as a powder or lamina, introducing the metal into a container having an open face under an inert gas atmosphere, and fastening a connection unit allowing a solvent to be introduced into the face and a vacuum state to be created (S2 step);
achieving a temperature equilibrium by maintaining an ambient temperature at a boiling or freezing point of the solvent after maintaining the vacuum state for a predetermined time using the connection unit, and introducing the solvent through the connection unit (S3 step);
preparing a solution by mixing the metal with the solvent in the container homogenously (S4 step); and
storing the container at −10 to 10° C. to allow the solution to expand and flow out through the connection unit (S5 step).

8. The method of claim 7, wherein the S5 step further comprises repeating steps from the S3 step such that the color of the solution becomes dark indigo.

9. The method of claim 7, wherein the solvent has a characteristic of reversible multi-step phase-transitions represented by chemical formula 1,
[M(R)ₙ]^{+a}(s)+ae⁻(in R solution) [symbol] [M(R)ₙ₋ₐ](s)+aR(g)−Qₙ(J) <Chemical Formula 1>
(M: Metal, R: Solvent, n=1, 2, . . . , 6, a=1, 2, . . . , 6, and Qₙ(J): amount of latent heat in the n^{th} step phase transition).

10. The method of claim 9, wherein the ratio of the metal to the solvent is 1:0.1 to 1:6.

11. The method of claim 7, wherein the metal is at least one selected from the group consisting of lithium, barium, boron, sodium, magnesium, aluminum, potassium, calcium, scandium, vanadium, chromium, manganese, iron, cobalt, nickel, copper, gallium, selenium, rubidium, strontium, yttrium, niobium, molybdenum, technetium, ruthenium, rhodium, palladium, silver, indium, tellurium, cesium, lanthanide metals, and actinide metals.

12. The method of claim 7, wherein the solvent is ammonia, ethylene diamine, hexamethylene diamine, melamine or amines with a carbon number of 4 or less as the length of the main chain, and salts thereof, amines containing phenyl groups and salts thereof, a polymer containing amides which include polyethylene amines in the main chain or polyamines which have amines connected to the main chain.

13. The method of claim 7, wherein the solvent is at least one selected from the group consisting of dimethyldistearylammonium, trimethyltetradecyl ammonium, trimethyihexadecyl ammonium, trimethyloctadecyl ammonium, benzyltrimethyl ammonium, benzyltriethyl ammonium, phenyltrimethyl ammonium, and aromatic quaternary ammoniums, cationic surfactants, and cationic polymers.

14. A method of manufacturing a module using a phase-transitional material, comp rising
removing oxygen and moisture in air by placing a metal under a vacuum condition (S1 step);
preparing the metal as a powder or lamina, introducing the metal into each of a first and a second containers having an open face under an inert gas atmosphere, and fastening each of a first and a second connection units allowing a solvent to be introduced into the face and a vacuum state to be created (S2 step);
*achieving a temperature equilibrium by maintaining an ambient temperature at a boiling or freezing point of the solvent after maintaining the vacuum state for a predetermined time using the first and the second connection units, and introducing the solvent through the first and the second connection units (S3 step);
preparing a solution by mixing the metal with the solvent in the first and the second containers homogenously (S4 step);
storing the container at −10 to 10° C. to allow the solution to expand and flow out through the first and the second connection units (S5 step); and
connecting the first and the second containers at room temperature and inserting an insulating material inbetween (S6 step).

15. The method of claim 14, wherein the S5 step further comprises repeating steps from the S3 step such that the color of the solution becomes dark indigo.

16. The method of claim 14, wherein the solvent has a characteristic of reversible multi-step phase-transitions represented by chemical formula 1,
[M(R)ₙ]^{+a}(s)+ae⁻(in R solution) [symbol] [M(R)ₙ₋ₐ](s)+aR(g)−Qₙ(J) <Chemical Formula 1>
(M: Metal, R: Solvent, n=1, 2, . . . , 6, a=1, 2, . . . , 6, and Qₙ(J): amount of latent heat in the n^{th} step phase transition).

17. The method of claim 16, wherein the ratio of the metal to the solvent is 1:0.1 to 1:6.

18. The method of claim 14, wherein the metal is at least one selected from the group consisting of lithium, barium, boron, sodium, magnesium, aluminum, potassium, calcium, scandium, vanadium, chromium, manganese, iron, cobalt, nickel, copper, gallium, selenium, rubidium, strontium, yttrium, niobium, molybdenum, technetium, ruthenium, rhodium, palladium, silver, indium, tellurium, cesium, lanthanide metals, and actinide metals.

19. The method of claim 14, wherein the solvent is ammonia, ethylene diamine, hexamethylene diamine, melamine or amines with a carbon number of 4 or less as the length of the main chain, and salts thereof, amines containing phenyl groups and salts thereof, a polymer containing amides which include polyethylene amines in the main chain or polyamines which have amines connected to the main chain.

20. The method of claim 14, wherein the solvent is at least one selected from the group consisting of dimethyldistearylammonium, trimethyltetradecyl ammonium, trimethylhexadecyl ammonium, trimethyloctadecyl ammonium, benzyltrimethyl ammonium, benzyltriethyl ammonium, phenyltrimethyl ammonium, and aromatic quaternary ammoniums, cationic surfactants, and cationic polymers.
